(19) United States
(12) Patent Application Publication
(10) Pub. No.: US 2009/0033683 A1
(43) Pub. Date: Feb. 5, 2009

(54) Method, system and apparatus for intelligent resizing of images

(76) Inventors: Jeremy Schiff, Berkeley, CA (US); Dominic Antonelli, Berkeley, CA (US); Frank Wang, Berkeley, CA (US); Neil Warren, Berkeley, CA (US); Heston Liebowitz, Emeryville, CA (US); Jonathan Burgstone, San Francisco, CA (US); Sharam Shirazi, Berkeley, CA (US)

Correspondence Address: PERKINS COIE LLP, P.O. BOX 1208, SEATTLE, WA, 98111-1208, US

(21) Appl. No.: 12/157,932

(22) Filed: Jun. 13, 2008

Related U.S. Application Data
(60) Provisional application No. 60/975,928, filed on Sep. 28, 2007.
(60) Provisional application No. 60/943,604, filed on Jun. 13, 2007.
(60) Provisional application No. 60/943,607, filed on Jun. 13, 2007.
(60) Provisional application No. 60/975,917, filed on Sep. 28, 2007.

(51) Int. Cl. G09G 5/00

(52) U.S. Cl. 345/661

(57) ABSTRACT

A new approach contemplating a variety of improved methods and systems to perform intelligent image resizing on an image is proposed. The approach enables a user to interactively mark or select portions of the image to preserve and/or remove. An energy function can then be used to calculate values of an energy metric, for a non-limiting example, entropy, on every pixel over the entire image. Such calculated values can then be used to determine the optimal regions where new pixels are to be inserted or existing pixels are to be removed in order to minimize the amount of energy lost (for shrinking) or added (for growing) in the image.

### RELATED APPLICATIONS

This application claims priority to U.S. Provisional Patent Application No. 60/975,928, filed Sep. 28, 2007, and entitled “Method, system and apparatus for intelligent resizing of images,” by Frank Wang et al. (Docket No. 63712-8005.US00), and is hereby incorporated herein by reference.

This application claims priority to U.S. Provisional Patent Application No. 60/943,604, filed Jun. 13, 2007, and entitled “Sampling-based image pixel selection,” by Jeremy Schiff et al. (Docket No. 63712-8001.US00), and is hereby incorporated herein by reference.

This application claims priority to U.S. Provisional Patent Application No. 60/943,607, filed Jun. 13, 2007, and entitled “Altering images using spatial distortion applied to scaleable regions,” by Jeremy Schiff et al. (Docket No. 63712-8002.US00), and is hereby incorporated herein by reference.

This application claims priority to U.S. Provisional Patent Application No. 60/975,917, filed Sep. 28, 2007, and entitled “Method, system and apparatus for seamless image insertion into cutout images,” by Jeremy Schiff et al. (Docket No. 63712-8003.US00), and is hereby incorporated herein by reference.

### FIELD OF INVENTION

The present invention relates to the field of image editing.

### BACKGROUND

There are two methods commonly used to resize (increase or decrease) the size of an image-cropping and proportional resizing. With cropping, a sub-region of the image is retained, while some external region of the image is discarded, resulting in a smaller image. With proportional resizing, vertical or horizontal lines (depending on the direction of the resizing) are chosen at uniform intervals in the image, and the pixels of the image are interpolated to fill in the new spaces created by the resizing. For instance, if the image is doubled in width, vertical columns of pixels would be inserted in between every current column of pixels. The values of the newly inserted pixels would be determined according to some interpolation method such as linear or quadratic of the values of the existing pixels surrounding the newly inserted ones. The common problem with both cropping and proportional resizing is that they do not take the information (texture) contained in the image into account when resizing the image.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 depicts a diagram of an example of a system to support intelligent image resizing.

FIG. 2 depicts a flowchart of an example of a process to support intelligent image resizing.

FIGS. 3(a)-(c) depict an example of intelligent image resizing using the process depicted in FIG. 2.

FIG. 4 depicts a flowchart of an example of a process to support selection of portions of an image for modification.

FIGS. 5(a)-(f) depict an example of applying a color distortion to selected portion of an image using the process depicted in FIG. 4.

FIG. 6 depicts a flowchart of an example of a process to support spatial distortions of an image.

FIG. 7 depicts an example of a bulge effect, stretching pixels proportionally to distance from the center.

FIG. 8 depicts a flowchart of an example of a process to support improved insertion of a user image into a cutout image.

FIGS. 9(a)-(b) depict an example of integrating a user's image into a cutout image using the process depicted in FIG. 8.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach contemplates a variety of improved methods to perform intelligent image resizing on an image, wherein intelligent resizing increases or decreases the size of the image, or alternatively keeps the size of the image unchanged while preserving and/or removing certain portion from the image. More specifically, the approach enables a user to interactively mark or select portions of the image for preservation and/or removal. An energy function can then be used to calculate values of an energy metric, for a non-limiting example, entropy, on every pixel over the entire image. Such calculated values can then be used to determine the optimal regions where new pixels are to be inserted or existing pixels are to be removed in order to minimize the amount of energy lost (for shrinking) or added (for growing) in the image. By performing additional energy analysis of the image before resizing the image, the proposed approach takes texture information of the image into account, resulting in a smoother and more natural resized image and allowing the user to resize the image while keeping the most important portions of the image intact.

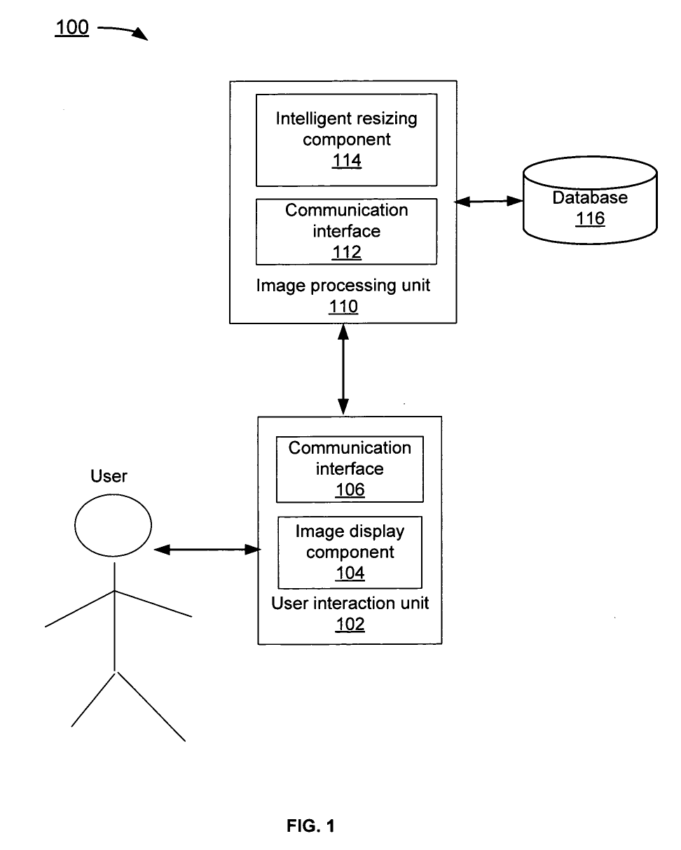

FIG. 1 depicts an example of a system diagram 100 to support intelligent image resizing. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a user interaction unit 102, which includes at least an image display component 104 and a communication interface 106, an image processing unit 110, which includes at least a communication interface 112 and an intelligent resizing component 114, and an optional database 116 coupled to the image processing unit 110. The term “unit,” as used herein, generally refers to any combination of one or more of software, firmware, hardware, or other component that is used to effectuate a purpose.

In the example of FIG. 1, each of the user interaction unit 102, the image processing unit 110, and the database 116 can run on one or more hosting devices (hosts). Here, a host can be a computing device, a communication device, a storage device, a global positioning device (GPS), or any electronic device capable of running software. For non-limiting examples, a computing device can be but is not limited to, a laptop PC, a desktop PC, a tablet PC, an iPod, a cell phone, a PDA, or a server machine. A storage device can be but is not limited to a hard disk drive, a flash memory drive, or any portable storage device. A communication device can be but is not limited to a mobile phone, or a computer with internet connection.

In the example of FIG. 1, the user interaction unit 102 enables the user to choose the image he/she would like to edit/resize, wherein the image can optionally be stored/managed in and retrieved from the database 116. In addition, the user interaction unit 102 enables the user to identify or select a portion of the selected image and mark such portion for preservation or removal. The user interaction unit 102 can then accept instructions (options) submitted by the user on how to edit (e.g., resize) the image, communicate with the image processing unit 110, present the resized image to the user in real time, and offer the user with the option to accept or undo any changes that have been made interactively.

In the example of FIG. 1, the image display component 104 in the user interaction unit 102 is a software component, which enables a user to view the images before and after the editing/resizing operation is performed on the image by the image processing unit 110, where the image may include portions of the image that are marked for preservation or removal by the user. In addition, the image display component 104 is also operable to present various image editing/resizing options to the user, where such options include but are not limited to, direction (horizontal, vertical or both) of the resizing, ways to mark the portion of the image for preservation or removal (e.g., via automated object identification and/or user-specification), and the ways the intelligent resizing is to the performed (e.g., incrementally one set of pixels at a time or one-step to completion). One of the key objectives of the image display component 104 is to make the image editing process as visually interactive and intuitive as possible to the user in order to make it easier for the user to achieve the desired editing effect of the image.

In the example of FIG. 1, the intelligent resizing component 114 in the image processing unit 110 performs intelligent resizing on the image selected by the user by first calculating energy values of an evaluation metric on energy (e.g., texture) contained in each pixel over the entire image according to a user-defined energy function. For non-limiting examples, such energy function can be but is not limited to, entropy, first and/or second order derivations of values of the pixels of the image. The energy function can be single-pixel based, patch-based, or even be a global function over the entire image. An important property of the evaluation metric is that it can adequately reflect the user's marked portion for preservation or removal in the image. For example, portions in the image that are marked for preservation or removal should have significantly different (much higher or lower) values compared to values of the unmarked portion of the image. Once the energy values of the evaluation metric have been calculated, the intelligent resizing component 114 chooses a path through the image based on the calculated energy values. Here, the path is a connected sequence of pixels across the image from one side of the image to another, reflecting the energy values of the evaluation metric of the image. For a horizontal path, two pixels are connected if one is to the upper, center, or lower left of another; for a vertical path, two pixels are connected if one is to the upper left, center, or right of another. The path is not necessarily a straight column or row of pixels, as it is chosen based on certain criteria across the image. For a non-limiting example, the path can be the lowest energy or the least resistive path through the image. The intelligent resizing component 114 then either removes the path from the image (when shrinking the image or removing a portion from it) or inserts or duplicates more of it in the image (when expanding the image or growing it back to its original size after shrinking) depending on the resizing operation being performed. The intelligent resizing component 114 may perform the path identification and insertion/removal process repeatedly until the editing effect on the image desired by the user is achieved (e.g., the portion marked for removal completely deleted).

In the example of FIG. 1, the optional database 116 coupled to the image processing unit 110 manages and stores various kinds of information related to the images of the user's interest. Such information includes but is not limited to one or more of the following:
Images, photos, pictures, graphics, which can either be user-generated and/or uploaded, or generated and made available to the user by a third party. Such images can be either in their original versions unmodified or unrevised by the user, or in versions revised and updated by the user via the system 100.
Log files, which record the detailed history of all revisions made by the users to the images in the database during the current and/or any of the previous image editing sessions. Such information may help to the user to trace the changes he/she made to the images and to restore the images to the original and any of the interim versions if necessary.
   Here, the term database is used broadly to include any known or convenient means for storing data, whether centralized or distributed, relational or otherwise.

In the example of FIG. 1, the user interaction unit 102 and the image processing unit 110 can communicate and interact with each other either directly or via a network (not shown). Here, the network can be a communication network based on certain communication protocols, such as TCP/IP protocol. Such network can be but is not limited to, internet, intranet, wide area network (WAN), local area network (LAN), wireless network, Bluetooth, WiFi, WiMax, and mobile communication network. The physical connections of the network and the communication protocols are well known to those of skill in the art.

In the example of FIG. 1, each of the communication interfaces 106 and 112 is a software component running on the user interaction unit 102 and image processing unit 110, respectively, which enables these units to reach, communicate with, and/or exchange information/data/images with each other following certain communication protocols, such as TCP/IP protocol or any standard communication protocols between two devices.

While the system 100 depicted in FIG. 1 is in operation, the user interaction unit 102 enables a user to select an image stored in database 116 for editing (intelligent resizing), and presents the selected image as well as options available for the editing to the user via the image display component 104. In addition to choose editing operations, the user may identify or mark certain portions on the image to be preserved or removed via the image display component 104. Upon accepting the user's marked preferences and editing instructions via communication interfaces 106 and 112, the intelligent resizing component 114 calculates energy values of an evaluation metric on energy over the entire image based an energy function that reflects the user-marked portions of the image. The intelligent resizing component 114 then identifies a path across the image from one side to another based on the calculated values, and performs the editing operation on the image by removing and/or inserting the path in the image. The resulting image from the processing by the image processing unit 110 is interactively presented to the user via the image display component 104 in real time and the user is offered options to either accept or decline changes made.

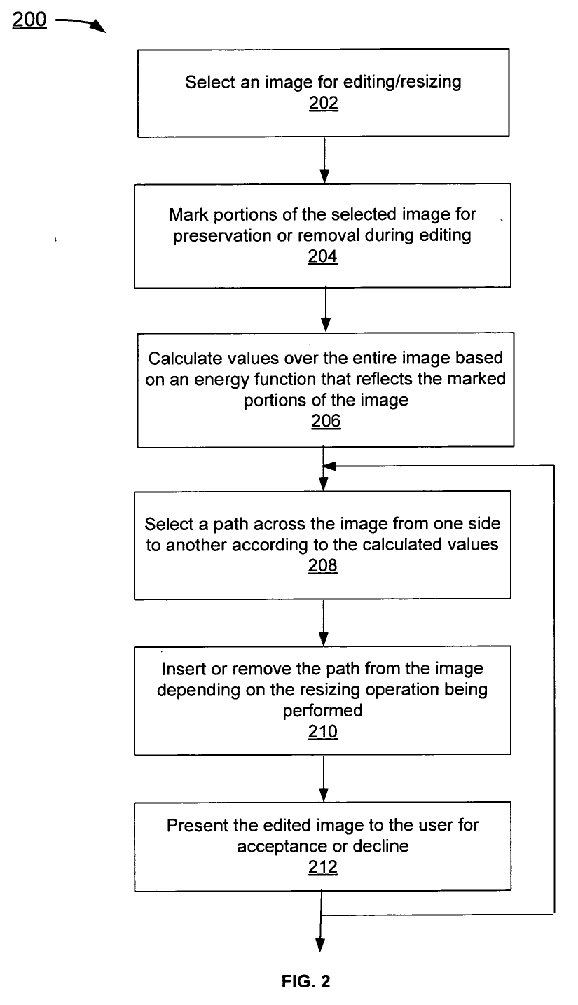

FIG. 2 depicts a flowchart of an example of a process to support intelligent image resizing. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 2, the flowchart 200 starts at block 202 where an image is selected by a user for editing/intelligent resizing. The flowchart 200 continues to block 204 where portions of the selected image are marked by the user for preservation or removal during editing. The flowchart 200 continues to block 206 where values are calculated over the entire image based on an energy function which reflects the portions marked by the user. The flowchart 200 continues to block 208 where a path is selected across the image from one side to another according to the calculated values. The flowchart 200 continues to block 210 where the path is either inserted into, or removed from the image depending on the resizing operation desired by the user. The flowchart 200 continues to block 212 where the revised image is presented interactively to the user for acceptance or decline. The flowchart 200 may execute block 208, 210, and 212 repeatedly until effect desired by the user is achieved.

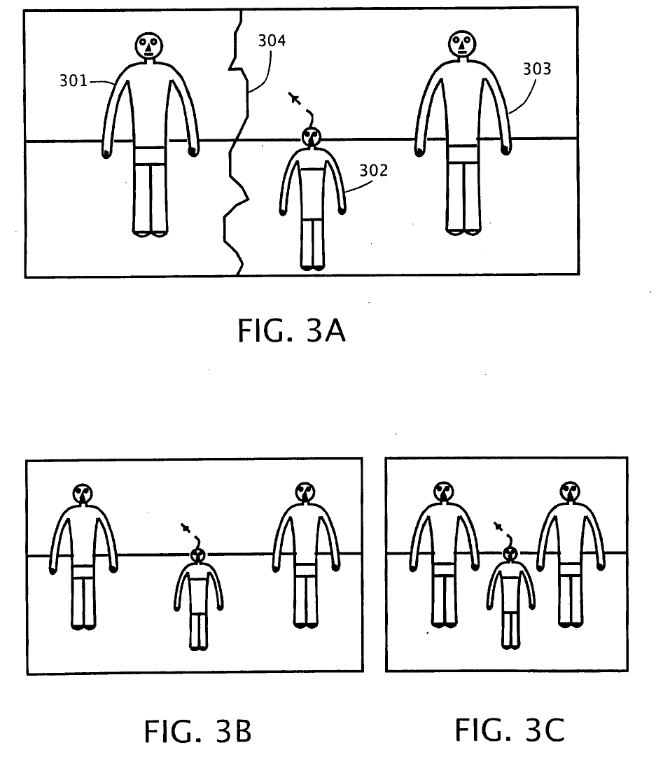

FIGS. 3(a)-(c) depict an example of intelligent image resizing using the process described above. FIG. 3(a) shows an original image on which the user intends to perform a horizontal resizing while preserving the three human FIGS. 301, 302 and 303 in the image. A vertical path 304 of pixels having the least energy is identified, which cut through “least interesting” portion of the image, e.g., the sky and the beach, while avoiding the human figures. FIGS. 3(b)-(c) show result of the horizontal resizing wherein the identified paths like 304 are repeatedly removed from the image while preserving human FIGS. 301-303 in the image intact.

In some embodiments, the user interaction unit 102 is operable to perform a face and/or object detection in the image automatically with no input from the user, or to perform such object detection at or near a region in the image marked by the user. For a non-limiting example, once the user marks the head of a person, the user interaction unit 102 may automatically detect and mark the whole body of person for preservation or removal. Here, any object and/or face detection techniques known to one skilled in the art may apply. Alternatively, the user interaction unit 102 is operable to identify only the portion of the image marked by the user for preservation or removal. To this end, the user interaction unit 102 enables the user to use highlighting tools, such as paint-brush-like strokes across the image and provides various sizes of the brush to the user so that the user can designate fine/tiny areas in the image for preservation or removal, such as an accessory on a person. Alternatively, the user may perform object selection by highlighting object edges or similar colors of the objects. Such fine-tuned free form object highlighting provides high level of flexibility to the user when the user intends to perform only minor changes to the image.

In some embodiments, the intelligent resizing component 114 can choose to apply one or more of a set of energy functions to the entire image as different energy functions may produce different results on different classes/types of images. For a non-limiting example, one energy function can compute intensity of a black and white image converted from a RGB colored image by the formula of:

energy intensity=R*0.3+G*0.59+B*0.11,

and then subtract a 4×4 pixel Gaussian blur filter of the image from the original. This filter delivers good estimates on the energy of the image and it is faster than other formulations such as Histogram of Gradients (HOG). Alternatively, an energy-function can be applied over a colored image directly, processing each of the red, green, and blue components in the image independently, and then “fusing” them together rather than creating a grayscale image for processing as described above.

In some embodiments, the intelligent resizing component 114 identifies the optimal set of pixels of the path across the image using a dynamic programming approach. Here, the formulation used by the dynamic programming approach chooses to minimize the sum of squares of the energy values of the pixels along the path instead of the sum of the values. Under such formulation, the selected path is better able to address outliers of the image by avoiding small patch of the image having a lot of energy. Other solutions for identifying the path based on energy values, such as an minimizing the product of the energy values along the path or selecting the path with the minimum median of the energy values, can also be used.

In some embodiments, the intelligent resizing component 114 identifies, and removes or inserts path incrementally one (or a small group) at a time. Here, resizing one path at a time implies producing a new image with one dimension shrunk by a single pixel, and then repeating such a process. For example, when removing a marked portion of the image while keeping the size of the image intact, the intelligent resizing component 114 identifies and removes a single path, then identifies and “grows back” a single replacement path, and repeats the process until the entire portion of the image marked for removal is actually removed. Here, conventional image interpolation functions can be applied to determine the values of these new pixels to be inserted and the single path can be identified greedily as the horizontal or vertical path having a smaller energy value. In some embodiments, it might be more efficient to just build a new image with many pixels removed. In contrast to removing the entire marked portion and then growing the image back to its original size all at once, the “one path at a time” approach treats identification and insertion/deletion of each path as a separate problem, and allows the user to inspect the resizing image every step of the way to fine tune the final result with high degree of flexibility, making the whole image editing process more visually appealing as it seems that the marked portion is being squished out of the image instead of being deleted.

In some embodiments, the intelligent resizing component 114 chooses the locations in the image where paths are to be deleted or inserted far from one another so that a clustering of replicated pixels is not noticed easily by someone viewing the modified image. To this end, the intelligent resizing component 114 modifies the final weights of the energy values used in dynamic programming to artificially increase the energy of the pixels close to paths already chosen by, for a non-limiting example, adopting the metric of inverse distance weighting. Such an approach has the bias effect of choosing subsequent paths far away from the previous path that has been chosen.

In some embodiments, the intelligent resizing component 114 identifies a set of paths having low energy values and selects one of the paths for insertion or removal. When adding paths, the criteria for the selection of the path from the set of paths can be either the selection of the k smallest paths, or the random selection of k paths, with replacement, where the selection is performed according to the inverse path energy. The latter has the effect of allowing paths to be re-used if their energy is significantly less than other paths. For removal, in addition to these path selection methods, the algorithm can delete a path, then treat the image as new, and re-compute the next optimal path.

In some embodiments, the energy values of the image can be updated incrementally. When a pixel-based energy function is used, the pixels along the selected path can simply be deleted without re-computing the energy function over the entire image again. When a patch-based energy function is used, only the energy values of the localized area of pixels affected by a deleted path need to be updated. For instance, if the energy function was over a 3×3 patch, and a vertical path was deleted, only locations in the energy map that are horizontally adjacent to a removed pixel needs to be re-calculated.

In some embodiments, the system 100 depicted in FIG. 1 provides a user with the ability to easily modify complex regions of an image via distortions and color changes. When editing photos, a user often wants to select and modify just a selected region. For instance, the user might want to just select skin color in order to give the person a tan, or the user might want to select a shirt to make it look larger. Programs like Photoshop allows the user to select a region using a flood-fill like tool called a “magic wand”, but this typically takes many clicks to select complex regions. In addition, these tools typically only provide one way of cutting out a region. Other tools may allow the user to draw a mask over a region and then apply some filter (usually color-based to the image under the mask), but such process can be very tedious. In contrast, the system 100 uses sophisticated algorithms (e.g., statistical learning and/or classification algorithms such as AdaBoost statistical classifier) to allow the user to select complex regions and then use these regions to cut out regions, or to apply color and position distortions. Here, any classification method that uses samples (good, and possibly also bad) as input, and provides predictions for un-classified pixels can be used and any potential approaches that can classify or predict are applicable, not limited to just those labeled as “statistical classifiers”.

In some embodiments, the system 100 enables the user to easily describe to a system what portion of an image he/she would like to modify by providing samples from that region. This description, for a non-limiting example, can be based on color or structure (like automatic face detection). Once such a region has been selected, distortions can be applied, color or spatial based, to modify the current image however the user wishes. The system 100 contemplates a variety of improved techniques using sampling-based methods to select regions of interest in an image for color or spatial manipulation. Such an approach is novel because it uses samples over an entire region, as opposed to selecting a region according to similar colors in a localized patch like a flood-fill, or selecting a region explicitly with a flood tool. For a non-limiting example, this approach may be used to cut out a complicated mask on a person's face, or to select a person's skin to make it more tan.

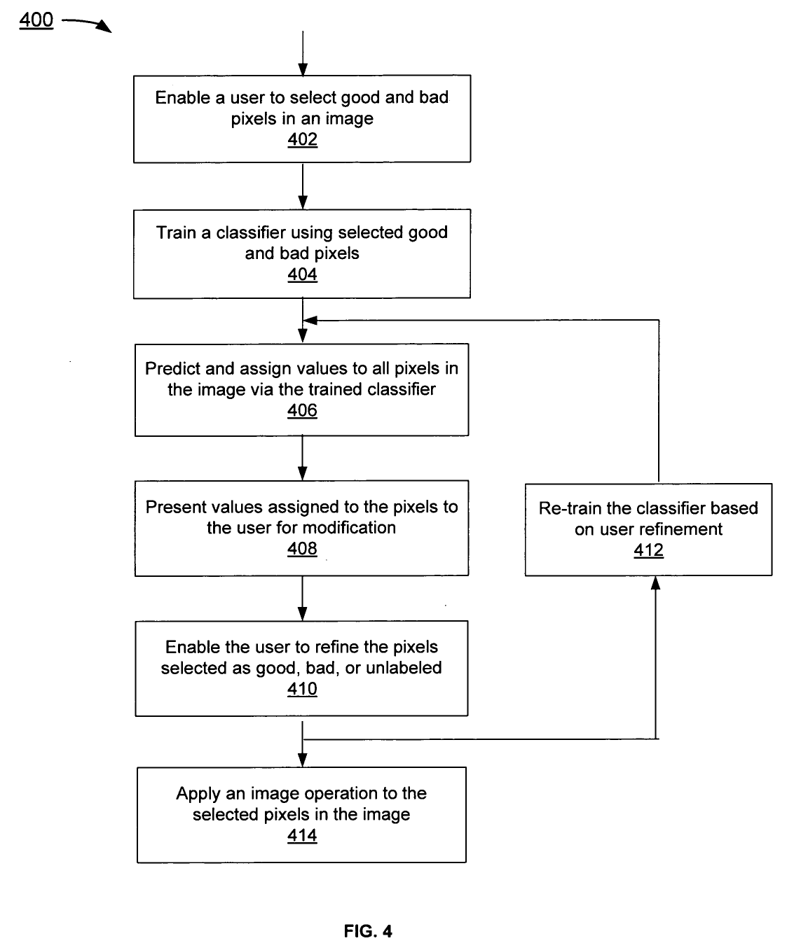

FIG. 4 depicts a flowchart of an example of a process to support selection of portions of an image for modification. In the example of FIG. 4, the flowchart 400 starts at block 402 where “good pixels” and “bad pixels” in an image are selected by a user. The flowchart 400 continues to block 404 where the good pixels and bad pixels are used to train a classifier, which will predict if an unselected pixel should be labeled as good or bad. The flowchart 400 continues to block 406 where the classifier is used to predict and assign values for all pixels in the image. The flowchart 400 continues to block 408 where the values assigned to the pixels are presented to a user for modification. The flowchart 400 continues to block 410 where the user refines the pixels selected as “good”, “bad”, or “unlabeled”. Here, the user has two options when refining the pixels: either to directly change the predicted values assigned to the pixels by the classifier, or change the set of good or bad pixels gathered before classification via a user interface which will implicitly modify the model the classifier is trained by and in turn produce a refined prediction of all unlabeled pixels. The flow chart 400 optionally continues from block 410 to block 412, where the updated user refinements are used to update the classifier. The flow chart 400 continues from block 412 back to block 406, which can be repeated until only pixels desired by the user are selected. The flowchart 400 ends at block 414 from block 410 where an image operation can be applied to the set of pixels selected.

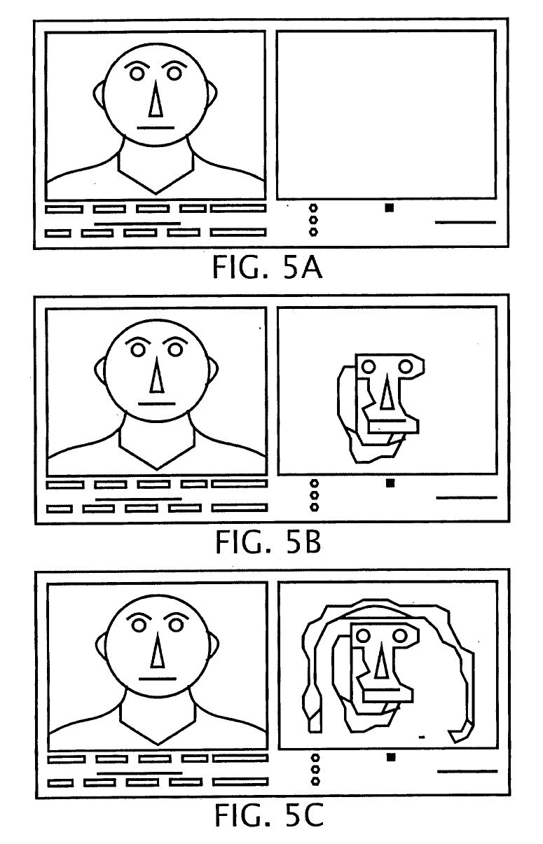

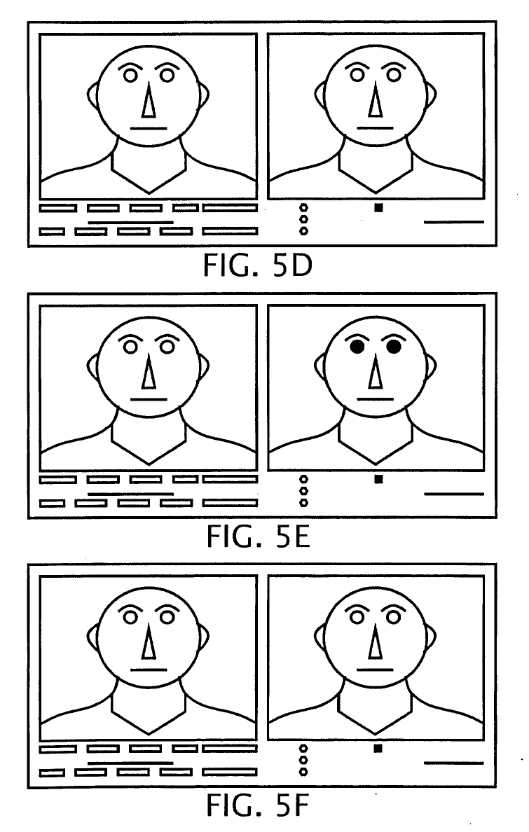

FIGS. 5(a)-(f) depict an example of applying pixel selection of an image using the process described above. The process begins with an original image (FIG. 5 (a)), and then enables the user to use a paint-brush tool to select the skin of a person (FIG. 5 (b)). In FIG. 5(c), the user specifies pixels they do not want to select, namely the area around the head. Then, as shown in FIG. 5(d), the user can use some prediction or classifier to determine the values of new pixels. In FIG. 5(e), the user does two things—firstly, he/she refines the prediction and iterates according to the performance of the previous version; Secondly, the user explicitly informs the system 100 to un-classify certain pixels so that newly sampled data could be used to refine the selection of “good pixels”. FIG. 5(f) provides the final result of the image.

In some embodiments, the system 100 depicted in FIG. 1 provides a user with the ability to perform spatial (localized or global) distortions to scaleable regions with a single click when editing photos. Instead of applying simplified distortions, such as blur, or sharpen over an image, over an entire image, the system 100 allows the user to select a scalable region (up to the entire image) of his/her interest to apply a distortion such as a swirl, bulge, horizontal squish, etc. A preview of the distortion is overlaid onto the image, allowing for the user to observe the effect of the distortion, and to apply the spatial distortion to the selected portion of the image via a single click.

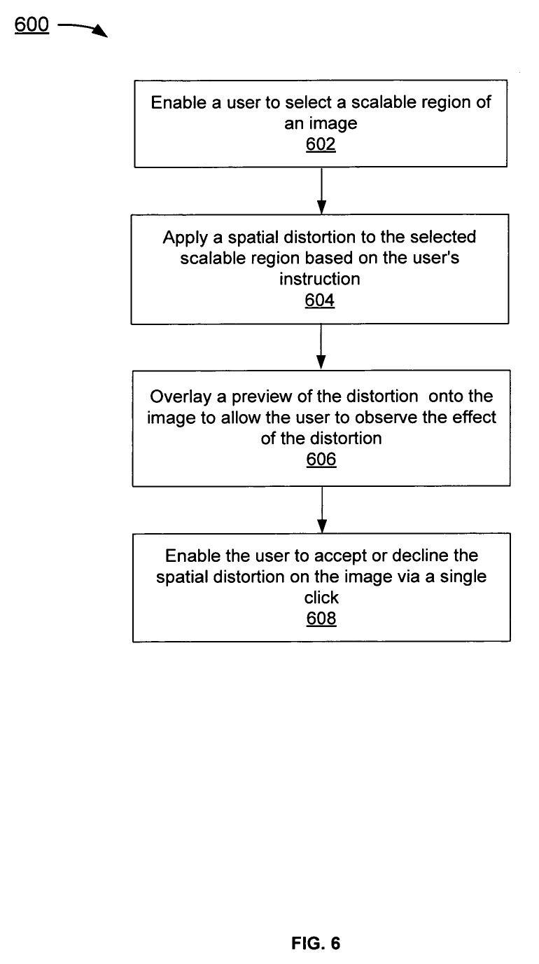

FIG. 6 depicts a flowchart of an example of a process to support spatial distortions of an image. In the example of FIG. 6, the flowchart 600 starts at block 602 where a scalable region of an image of a user's interest is selected by the user. The flowchart 600 continues to block 604 where a spatial distortion is applied to the selected scalable region based on the user's instruction. The flowchart 600 continues to block 606 where a preview of the distortion is overlaid onto the image to allow the user to observe the effect of the distortion. The flowchart 600 ends at block 608 where the spatial distortion on the image is accepted by declined by the user via a single click.

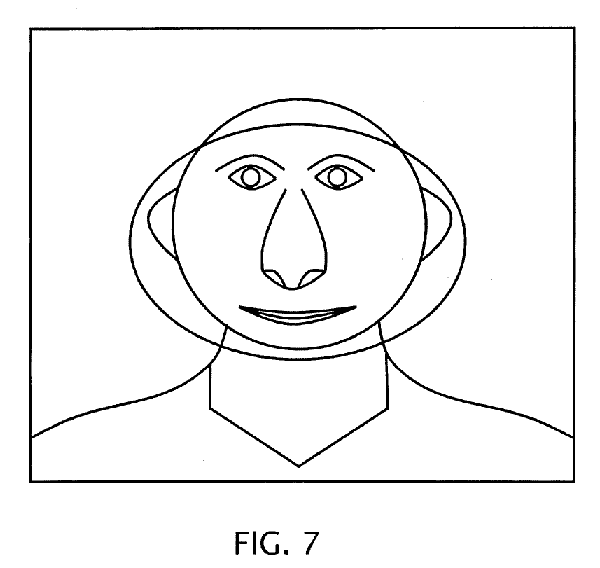

In some embodiments, the distortions applied typically consist of things like simple distortions in Cartesian or polar coordinates, but could also be arbitrarily complex functions. For a non-limiting example, a squish effect applies a distortion to the image, making pixels closer to the center of the bounding region closer together while the pixels further from the center having a greater distance between pixels, and interpolating in between. An example of a bulge effect, stretching pixels proportionally to distance from the center is provided in FIG. 7, which also demonstrates the concept of a preview overlay for single-click application of such a distortion.

In some embodiments, the system 100 depicted in FIG. 1 enables a user to insert a secondary image into a cutout image. People often wish to insert photos into cutouts in order to appear in situations that never actually occurred. For instance, a user may wish to create a photo of him/her being in the wild-west, or a photo of being on the cover of Time magazine. A system utilizing a very particular camera, lighting and background setup, modifying the camera angle and lighting, and finding a perfect photo that allows an operator to seamlessly place the photo into the cutout is too restrictive the user, as he/she has to go to a location that has such a setup. Alternatively, using a physical cutout that the person stands behind does not result in a seamless result and thus fails to make the person does not actually appear to be the person in the scene. Finally, performing some sort of explicit blending between the new image and the cutout requires much more sophistication from the user to get a quality result.

In some embodiments, the system 100 depicted in FIG. 1 contemplates a variety of improved methods and systems for inserting photos into a cutout, which provides for significantly better results than conventional approaches described above. It presents the user with a cutout image and places a new image of the user behind it. It utilizes current image(s) provided by the user and alters the properties of the foreground and background images to best fuse the two images together. Here, the cutouts are already pre-processed to have increased transparency near the center of the cutout region to make the image inserted behind the cutout appear to be merged more effectively with the cutout. In addition, image pre-processing can be performed on the cutout to determine an image transform on the image behind to maximize the amount the amount of consistency between the images. The overarching idea is to modify and process the cutout ahead of time to minimize the work of the user.

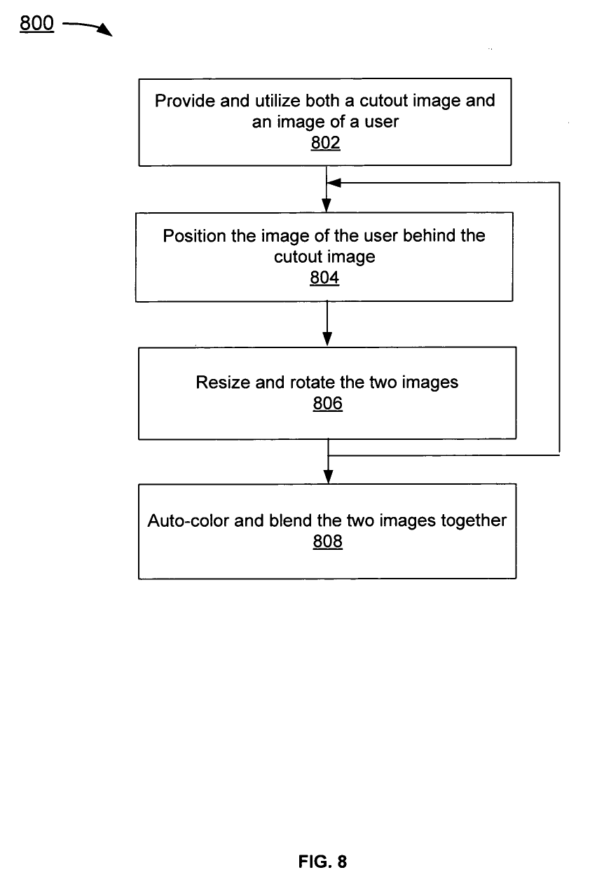

FIG. 8 depicts a flowchart of an example of a process to support improved insertion of a user image into a cutout image. In the example of FIG. 8, the flowchart 800 starts at block 802 where both a cutout image and an image of a user are provided and utilized. The flowchart 800 continues to block 804 where the image of the user is positioned behind the cutout image. The flowchart 800 continues to block 806 where properties of the two images are altered, e.g., resized and rotated. Blocks 804 and 806 can be repeated in ordered to best fuse the two images together. The flowchart 800 ends at block 808 where the two integrated images are auto-colored and blended together.

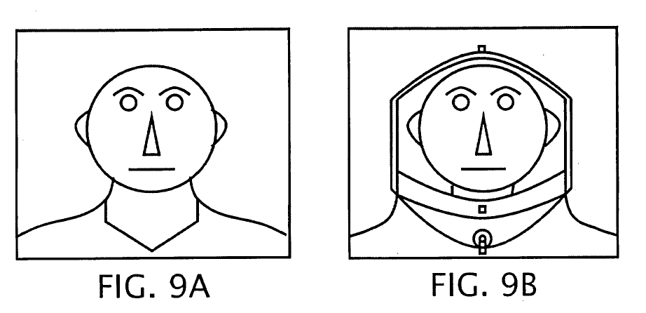

In some embodiments, rather than explicitly removing the entire cutout region (the area that will be replaced with the user's image), the region is faded to transparent into the center of the cutout region. This will have the effect of fuse the new image with the cutout far more seamlessly. Furthermore, image processing methods are applied to the image to determine a global filter to overlay onto the inserted image to fit the hue and saturation of the image using, for a non-limiting example, a Poisson image filter. Such processing is designed to modify the color of the region to be more consistent with the neighboring cutout region. Examples of such an approach include altering hue and saturation to be consistent with the neighboring cutout region. FIGS. 9(a)-(b) depict an example of integrating an user's image (FIG. 9(a)) into a cutout image as shown by FIG. 9(b) using the methods described above.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “interface” is used in the embodiments of the systems and methods described above, it will be evident that such concept can be interchangeably used with equivalent software concepts such as, class, method, type, module, component, bean, module, object model, process, thread, and other suitable concepts. While the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system, comprising:
a user interaction unit operable to:
enable a user to select an image for an editing operation;
enable a user to mark a portion of the selected image for preservation or removal during the editing operation;
provide information of the editing operation and the marked portion of the image to an image processing unit;
said image processing unit operable to:
accept the information of the editing operation and the marked portion of the image;
calculate energy value of each pixel of the image according to a user-defined energy function that reflects the marked portion of the image;
identify a path across the image from one side of the image to another according to the calculated energy values of the pixels in the image;
perform the editing operation by inserting or removing the path from the image

2. The system of claim 1, further comprising:
a database coupled to the image processing unit, wherein the database is operable to store and manage a set of images and/or information related to the set of images.

3. The system of claim 1, wherein:
the editing operation is one of resizing the image in horizontal direction, resizing the image in vertical direction, and removing the marked portion of the image while keeping size of the image unchanged.

4. The system of claim 1, wherein:
the user interaction unit is operable to provide the user with a set of image editing options, wherein the set of editing options is one of: direction of resizing, way to mark portion of the image for preservation or removal, and way to perform image resizing.

5. The system of claim 1, wherein:
the user interaction unit is operable to present the edited image to the user interactively in real time for the user's acceptance or decline.

6. The system of claim 1, wherein:
the user interaction unit is operable to perform face and/or object detection in the image automatically.

7. The system of claim 1, wherein:
the user interaction unit is operable to identify only the portion of the image marked by the user for preservation or removal.

8. The system of claim 1, wherein:
the energy function is one of entropy and first and/or second order derivations of values the pixels of the image.

9. The system of claim 1, wherein:
the energy function is single-pixel based, patch-based, a global function over the entire image.

10. The system of claim 1, wherein:
the energy function applies to a colored image directly or by first converting the colored image to black and white.

11. The system of claim 1, wherein:
the image processing unit is operable to perform the editing operation with the marked area for preservation kept intact.

12. The system of claim 1, wherein:
the image processing unit is operable to perform the editing operation with the marked area for removal deleted.

13. The system of claim 1, wherein:
the image processing unit is operable to identify optimal set of pixels of the path across the image using a dynamic programming approach.

14. The system of claim 1, wherein:
the image processing unit is operable to identify, remove or insert incrementally one path or a small group of paths at a time.

15. The system of claim 14, wherein:
the image processing unit is operable to enable the user to inspect the edited image after each path is inserted or removed.

16. The system of claim 1, wherein:
the image processing unit is operable to identify a set of paths and select one of the paths for insertion or removal randomly based on weight of the paths.

17. The system of claim 16, wherein:
the image processing unit is operable to choose locations where paths are to be deleted or inserted far from one another.

18. The system of claim 1, wherein:
the image processing unit is operable to update energy values of the image incrementally.

19. A computer-implemented method, comprising:
selecting an image for an editing operation;
marking a portion of the selected image for preservation or removal during the editing;
calculating energy value of each pixel over the entire image based on an energy function that reflects the marked portion of the image;
selecting a path across the image from one side to another according to the calculated energy values of the pixels in the image;
performing the editing operation by inserting or removing the path from the image.

20. The method of claim 19, further comprising:
presenting the edited image to a user initiating the editing operation for acceptance or decline interactively in real time.

21. The method of claim 19, further comprising:
performing face and/or object detection in the image automatically.

22. The method of claim 19, further comprising:
identifying only the portion of the image marked by the user for preservation or removal.

23. The method of claim 19, further comprising:
performing the editing operation with the marked area for preservation kept intact.

24. The method of claim 19, further comprising:
performing the editing operation with the marked area for removal deleted.

25. The method of claim 19, further comprising:
identifying optimal set of pixels of the path across the image using a dynamic programming approach.

26. The method of claim 19, further comprising:
Identifying, removing or inserting incrementally one path at a time.

27. The method of claim 19, further comprising:
identifying a set of paths and select one of the paths for insertion or removal randomly based on weight of the paths.

28. The method of claim 27, further comprising:
choosing locations of paths to be deleted or inserted far from one another.

29. A computer-implemented method, comprising:
enabling a user to select good and bad pixels in an image;
training a classifier using selected good and bad pixels;
predicting and assigning values to all pixels in the image via the trained classifier;
presenting values assigned to the pixels to the user for modification;
enabling the user to refine the pixels selected as good, bad, or unlabeled;
applying an image operation to the selected pixels in the image.

30. The method of claim 29, further comprising:
re-training the classifier based on user refinement.

31. A computer-implemented method, comprising:
enabling a user to select a scalable region of an image;
applying a spatial distortion to the selected scalable region;
overlaying a preview of the distortion onto the image to allow the user to observe effect of the distortion;
enabling the user to accept or decline the spatial distortion on the image via a single click.

32. A system, comprising:
means for selecting an image for an editing operation;
means for marking a portion of the selected image for preservation or removal during the editing;
means for calculating energy value of each pixel over the entire image based on an energy function that reflects the marked portion of the image;
means for selecting a path across the image from one side to another according to the calculated energy values of the pixels in the image;
means for performing the editing operation by inserting or removing the path from the image one or a small group of paths at a time.
